(19) United States
(12) Patent Application Publication
(10) Pub. No.: US 2023/0297983 A1
(43) Pub. Date: Sep. 21, 2023

(54) SYSTEMS AND METHODS FOR GRANTING SMART CONTRACTS

(71) Applicant: Capital One Services, LLC, McLean, VA (US)

(72) Inventors: Xiaoguang Zhu, New York, NY (US); Kevin Osborn, Newton Highlands, MA (US); Samuel Rapowitz, Roswell, GA (US)

(21) Appl. No.: 17/698,544

(22) Filed: Mar. 18, 2022

(51) Int. Cl. G06Q 20/12; G06Q 20/40; G06Q 50/18

(52) U.S. Cl. CPC G06Q 20/1235; G06Q 20/401; G06Q 50/184; G06Q 2220/18

(57) ABSTRACT

Systems and methods for granting smart contracts is disclosed. A first plurality of tokens representing a vote for a plurality of smart contract validators can be received from a first cryptographic address. The method can include receiving, from each smart contract validator of the plurality of smart contract validators, validation credentials. Each of the plurality of smart contract validators can be validated based on the validation credentials and the first plurality of tokens. a first smart contract and a second plurality of tokens can be received from a second cryptographic address. The first smart contract can be transmitted to at least one smart contract validator of the plurality of smart contract validators. The first smart contract can be validated by the at least one smart contract validator. At least a portion of the second plurality of tokens can be transmitted to the at least one smart contract validator.

### FIELD

The present disclosure relates generally to systems and methods for granting smart contracts, and more particularly, to a decentralized blockchain system that provides a decentralized alternative to a centralized patent examination system.

### BACKGROUND

Patents examination is a highly structured and centralized system in which a patent agency hires subject matter experts to be patent examiners. Patent examiners are assigned patent applications that are submitted to the patent agency, which then undergo examination for novelty and patentability. Patent examiners review patent applications and issue rejections, which patent applications attempt to overcome with amendments and arguments. Eventually, patent applications are either abandoned or issue as enforceable patents.

However, traditional patent systems suffer from many drawbacks. For example, traditional patent systems are plagued by inefficiencies and delays. It is not uncommon for a patent application to await examination by a patent examiner for more than a year before it is even assigned to a patent examiner. Accordingly, patentees in the traditional system seek alternative solutions for applying for, enforcing, and licensing intellectual property rights, such as patents.

Meanwhile, distributed decentralized blockchain technologies are revolutionizing a myriad of fields in the financial and tech sectors of the economy. Smart contracts implemented on a blockchain protocol can allow users of the blockchain to make complex transactions without a centralized authority. Accordingly, there is a need to provide for a system that can facilitate an alternative to a centralized patent system that is implemented using decentralized blockchain technology. This application is directed to this and other considerations.

### SUMMARY

Examples of the present disclosure provide solutions to the issues associated with a centralized patent examination system. The present disclosure describes a decentralized blockchain system that can implement smart contract systems that grant non-fungible tokens associated with a patent-like exclusive right to make, use, or sell an invention. The present disclosure also incentivizes participation in the system by rewarding users for reporting infringement events and incentivizes election of decentralized “patent examiners” by issuing tokens native to the blockchain system in response to granting rights to patent applications.

A system for granting smart contracts can include a plurality of distributed processors and a plurality of distributed non-transitory memories in communication with the plurality of distributed validation processors and storing instructions that when executed by the plurality of distributed processors are configured to cause the system to perform steps of a method. The method can include receiving, from a first plurality of cryptographic addresses, a first plurality of tokens representing a vote for a plurality of smart contract validators. The method can include receiving, from each smart contract validator of the plurality of smart contract validators, validation credentials. The method can include verifying each of the plurality of smart contract validators based on the validations credentials and the first plurality of tokens. The method can include receiving, from a second cryptographic address, a first smart contract and a second plurality of tokens. The method can include transmitting the first smart contract to at least one smart contract validator of the plurality of smart contract validators. The method can include validating the first smart contract by the at least one smart contract validator. The method can include transmitting at least a portion of the second plurality of tokens to the at least one smart contract validator. The method can include transmitting at least a portion of the second plurality of tokens to the at least one smart contract validator.

In another aspect, a system for granting smart contracts is disclosed. The system can include a plurality of distributed processors and a plurality of distributed non-transitory memories in communication with the plurality of distributed validation processors and storing instructions that when executed by the plurality of distributed processors are configured to cause the system to perform steps of a method. The method can include receiving, from a cryptographic address associated with a smart contract petitioner, a first smart contract and a first plurality of tokens. The method can include transmitting the first smart contract to at least one smart contract validator of a plurality of smart contract validators. The method can include validating the first smart contract by the at least one smart contract validator. The method can include transmitting at least a portion of the first plurality of tokens to the at least one smart contract validator. The method can include receiving, from a cryptographic address associated with a smart contract licensee, a request for a license to the first smart contract and a second plurality of tokens. The method can include receiving, from the cryptographic address associated with the smart contract petitioner, validation of the request. The method can include transmitting at least a portion of the second plurality of tokens to the cryptographic address associated with the smart contract petitioner.

In another aspect, a system for granting smart contracts is disclosed. The system can include a plurality of distributed processors and a plurality of distributed non-transitory memories in communication with the plurality of distributed validation processors and storing instructions that when executed by the plurality of distributed processors are configured to cause the system to perform steps of a method. The method can include receiving, from a first plurality of cryptographic addresses, a first plurality of tokens representing a vote for a plurality of smart contract validators. The method can include receiving, from each smart contract validator of the plurality of smart contract validators, validation credentials. The method can include verifying each of the plurality of smart contract validators based on the validation credentials and the first plurality of tokens.

These and other aspects of the present disclosure are described in the Detailed Description below and the accompanying figures. Other aspects and features of examples of the present disclosure will become apparent to those of ordinary skill in the art upon reviewing the following description of specific, exemplary examples of the present invention in concert with the figures. While features of the present disclosure can be discussed relative to certain examples and figures, all examples of the present disclosure can include one or more of the features discussed herein. Further, while one or more examples can be discussed as having certain advantageous features, one or more of such features can also be used with the various examples of the invention discussed herein. In similar fashion, while exemplary examples can be discussed below as device, system, or method examples, it is to be understood that such exemplary examples can be implemented in various devices, systems, and methods of the present invention.

### BRIEF DESCRIPTION OF THE DRAWINGS

The accompanying drawings, which are incorporated in and constitute a part of this specification, illustrate multiple examples of the presently disclosed subject matter and serve to explain the principles of the presently disclosed subject matter. The drawings are not intended to limit the scope of the presently disclosed subject matter in any manner In the drawings:

FIG. 1 is a diagram of an example system environment that can be used to implement one or more examples of the present disclosure;

FIG. 2 is a component diagram of an example validator node, according to the present disclosure;

FIG. 3 is a component diagram of an example cryptographic wallet, according to the present disclosure;

FIG. 4 is a flowchart of an example method for granting a smart contract, according to the present disclosure;

FIG. 5 is a flowchart of an example method for licensing a granted smart contract, according to the present disclosure; and

FIG. 6 is a flowchart of an example method for incentivizing reporting infringement events, according to the present disclosure.

### DETAILED DESCRIPTION

Examples of the present disclosure generally include systems and methods for granting smart contracts, and more particularly, to a decentralized blockchain system that provides a decentralized alternative to a centralized patent examination system. A benefit of the present systems and methods is that the blockchain system can issue tokens to validator nodes that review and grant smart contracts granting patent-like rights, thereby incentivizing participation in the blockchain system. Additionally, the blockchain system can reward users that report infringement events by issuing tokens to users that report said infringement events.

Incentives can be given to participants of the decentralized blockchain system by providing users a portion of rewards that are generated by validator nodes for validating transactions in a “proof of stake” system. For example, when a validator node successfully grants a smart contract, the validator node can be granted a new issuance of native tokens that can be used to incentivize participation by validation nodes and users reporting infringement activity. Accordingly, the disclosed blockchain system incentivizes saving by providing a way for a user to accrue tokens as a reward for contributing to the proof of stake blockchain ecosystem.

The systems and methods described herein are necessarily rooted in computer technology as they relate to digital security protocols to grant smart contracts. The entirety of the system is based upon blockchain technology, meaning the data is distributed among a plurality of end-user computers, which make up the nodes of the system. This environment is vastly different than a typical server/cloud system wherein one entity is in control of the transactions associated with the system. Instead, the blockchain system herein is able to leverage a proof of stake blockchain system to provide incentives for users of the system to increase participation in the system and increase the value of the native token.

Reference will now be made in detail to exemplary examples of the disclosed technology, examples of which are illustrated in the accompanying drawings and disclosed herein. Wherever convenient, the same reference numbers will be used throughout the drawings to refer to the same or like parts.

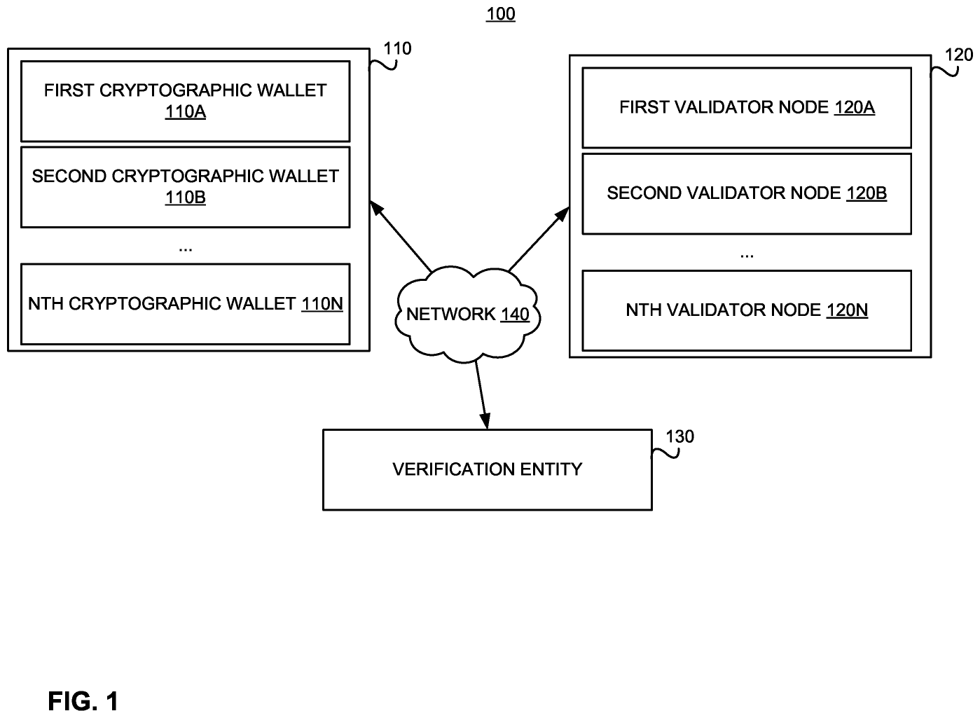

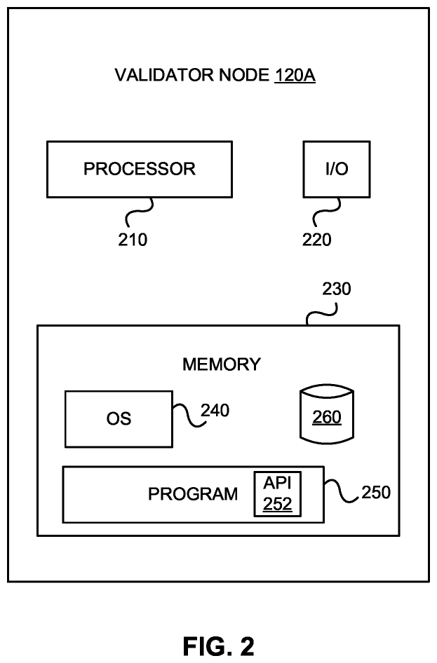

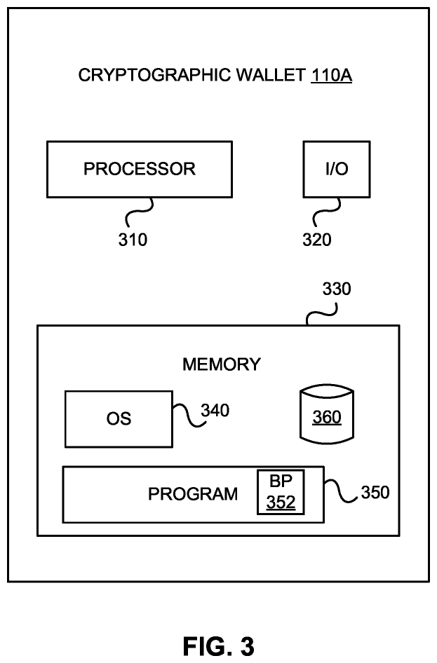

FIG. 1 is a diagram of an example system environment 100 environment that can be used to implement one or more examples of the present disclosure. A more detailed explanation of the components of the system environment 100 is provided below. It is beneficial, however, to provide a brief overview to describe the components of the systems and methods for granting smart contracts. The system environment 100 can include a plurality of cryptographic wallets 110, for example a first cryptographic wallet 110A, a second cryptographic wallet 110B, a third cryptographic wallet 110C, an N^{th} cryptographic wallet 110N, etc. As will be appreciated, there can be any number of cryptographic wallets 110 within the system environment 100. The system environment 100 can also include a plurality of validator nodes 120, for example a first validator node 120A, a second validator node 120B, a third validator node 120C, an N^{th} validator node 120N, etc. The system environment 100 can also include a verification entity 130. The cryptographic wallet environments 110, validator nodes 120, and verification entities 130 can be implemented by computing devices, such as a mobile computing device (e.g., smart phone, tablet computer, smart wearable, portable laptop computer, voice command device, wearable augmented reality device, or other mobile computing device) or a stationary device (e.g., a desktop computer, server, etc.), as will be described below with reference to FIGS. 2-3.

The components/nodes of the system 100 can communicate with each other over a wired or wireless network 140. The network 140 can, therefore, facilitate smart contract validations being made between cryptographic wallet environments 110, the validator nodes 120, and the infringement validator entities. In some examples, cryptographic wallet 110 can be implemented by a user device via an application installed on the user device.

According to some examples, the verification entity 130 can be a blockchain oracle. Blockchain oracles can bridge blockchain systems to real-world knowledge, facilitating smart contracts that are based on the occurrence of real-world events. For example, a blockchain oracle can provide information to system 100 from the non-blockchain world, including whether a respective smart contract granted by system 100 has been infringed upon by an entity. In another example, the verification entity can determine whether a patent examiner voted for by users of system 100 has the necessary credentials in order to become a validator node 120 within system 100.

Facilitating communication between components of system 100, the network 140 may be of any suitable type, including individual connections via the Internet such as cellular or WiFi networks. In some examples, the network 430 may connect terminals, services, and mobile devices using direct connections such as radio-frequency identification (RFID), near-field communication (NFC), Bluetooth™, low-energy Bluetooth™ (BLE), WiFi™, Ethernet, ZigBee™, ambient backscatter communications (ABC) protocols, USB, WAN, or LAN. Because the information transmitted may be personal or confidential, security concerns may dictate one or more of these types of connections be encrypted or otherwise secured. In some examples, however, the information being transmitted may be less personal, and therefore the network connections may be selected for convenience over security.

FIG. 2 is a component diagram of an example validator node 120, according to the present disclosure. Validator nodes receive requests from users (e.g., from cryptographic wallets 110) to grant smart contracts that provide an exclusive right to practice an invention. Additionally, validator nodes 120 compete to validate transactions, with a respective validator node 120 being probabilistically selected to validate a transaction (e.g., add a block to the distributed blockchain) based on a number of tokens staked by the respective validator node 120. The granted smart contracts requested by cryptographic wallets 110 are recorded as transactions to the blockchain by validator nodes 120, and the resultant blocks are broadcast to all other validator nodes 120 operating within the blockchain. Validator nodes 120 may include a processor 210, an input/output (“I/O”) device 220, a memory 230 containing an operating system (“OS”) 240, one or more program(s) 250, and a database 260. For example, validator node 120 may be a single device or a server or may be configured as a distributed computer system including multiple servers, devices, or computers that interoperate to perform one or more of the processes and functionalities associated with the disclosed examples. In some examples, validator node 120 may further include a peripheral interface, a transceiver, a mobile network interface in communication with processor 210, a bus configured to facilitate communication between the various components of validation node 120, and a power source configured to power one or more components of validator node 120. Servers, databases, and other computing devices (e.g., cryptographic wallet environment(s) 110 and/or verification entities 130) included in the system 100 may include many components that are similar to or even have the same capabilities as those described with respect to validator node 120.

A peripheral interface may include hardware, firmware and/or software that enables communication with various peripheral devices, such as media drives (e.g., magnetic disk, solid state, or optical disk drives), other processing devices, or any other input source used in connection with the instant techniques. In some examples, a peripheral interface may include a serial port, a parallel port, a general-purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

In some examples, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™ ambient backscatter communications (ABC) protocols or similar technologies.

A mobile network interface may provide access to a cellular network, the Internet, a local area network, or another wide-area network. In some examples, a mobile network interface may include hardware, firmware, and/or software that allows the processor(s) 210 to communicate with other devices via wired or wireless networks, whether local or wide area, private or public, as known in the art. A power source may be configured to provide an appropriate alternating current (AC) or direct current (DC) to power components.

The processor 210 may include one or more of a microprocessor, microcontroller, digital signal processor, co-processor or the like or combinations thereof capable of executing stored instructions and operating upon stored data. The memory 230 may include, in some implementations, one or more suitable types of memory (e.g., such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one example, the processing techniques described herein are implemented as a combination of executable instructions and data within the memory 230.

The processor 210 may be one or more known processing devices, such as a microprocessor from the Pentium™ family manufactured by Intel™ or the Turion™ family manufactured by AMD™. The processor 210 may constitute a single core or multiple core processor that executes parallel processes simultaneously. For example, the processor 210 may be a single core processor that is configured with virtual processing technologies. In certain examples, the processor 210 may use logical processors to simultaneously execute and control multiple processes. The processor 210 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

Validator node 120 may include one or more storage devices configured to store information used by the processor 210 (or other components) to perform certain functions related to the disclosed examples. In some examples, the validator node 120 may include a memory 230 that includes instructions to enable processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one example, validator node 120 may include memory 230 that includes instructions that, when executed by the processor 210, perform one or more processes consistent with the functionalities disclosed herein. Methods, systems, and articles of manufacture consistent with disclosed examples are not limited to separate programs or computers configured to perform dedicated tasks. For example, validator node 120 may include memory 230 that may include one or more programs 250 to perform one or more functions of the disclosed examples. Moreover, the processor 210 may execute one or more programs 250 located remotely from the validator node 120 (e.g., a program operating on cryptographic wallet environment 110). For example, validator node 120 may access one or more remote programs 250, that, when executed, perform functions related to disclosed examples.

The one or more programs 250 can include blockchain protocol (“BP”) 252.

Blockchain protocol 252 includes software that enforces the same rules for all validator nodes 120 that participate in system 100. BP 252 also includes rules regarding how a respective validator node 120 (e.g., validator node 120A) is selected to validate a smart contract and how validator nodes 120 are rewarded for being selected to grant a predetermined number of smart contracts by minting or creating additional cryptocurrency tokens and distributing them to the respective validator node (e.g., validator node 120A).

The memory 230 may include one or more memory devices that store data and instructions used to perform one or more features of the disclosed examples. The Memory 230 may also include any combination of one or more databases controlled by memory controller devices (e.g., server(s), etc.) or software, such as document management systems, Microsoft™ SQL databases, Mongo databases, SharePoint™ databases, Oracle™ databases, Sybase™ databases, or other relational or non-relational databases. The memory 230 may also include software, such as Hadoop™, enabling the system to store and process large volumes of data distributed across a cluster of commodity servers and commodity storage connected via the network 140. The memory 230 databases may consist of files on the system 100 that are simply read into the memory, and the disclosed examples are not limited to separate databases or even to the use of a database. The memory 230 may include software components that, when executed by the processor 210, perform one or more processes consistent with the disclosed examples. In some examples, the memory 230 may include a database 260 for storing related data to enable the system 100 to perform one or more of the processes and functionalities associated with the disclosed examples.

Validator node 120 may also be communicatively connected to one or more memory devices (e.g., databases) locally or through the network 140. The remote memory devices may be configured to store information and may be accessed and/or managed by bookmark validator nodes 120. By way of example, the remote memory devices may be document management systems, Microsoft™ SQL database, Mongo databases, SharePoint™ databases, Oracle™ databases, Sybase™ databases, or other relational or non-relational databases. The remote memory devices may also include software, such as Hadoop™, enabling them to store and process large volumes of data distributed across a cluster of commodity servers and commodity storage connected via the network 140. These memory devices may consist of files on the system 100 that are simply read into the memory, and the disclosed examples are not limited to separate databases or even to the use of a database. Systems and methods consistent with disclosed examples, however, are not limited to separate databases or even to the use of a database.

Validator nodes 120 may also include one or more I/O devices 220 that may comprise one or more interfaces for receiving signals or input from devices and providing signals or output to one or more devices that allow data to be received and/or transmitted by validator nodes 120. For example, validator nodes 120 may include interface components, which may provide interfaces to one or more input devices, such as one or more keyboards, mouse devices, touch screens, track pads, trackballs, scroll wheels, digital cameras, microphones, sensors, scanners, and the like, that enable validator nodes 120 to receive data from one or more users.

In exemplary examples of the disclosed technology, validator nodes 120 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While validator nodes 120 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of validator nodes may include a greater or lesser number of components than those illustrated.

FIG. 3 is a component diagram of an example cryptographic wallet environment 110, according to the present disclosure. According to some examples, cryptographic wallet environment 110 can be implemented by a computing device, such as a mobile device, desktop computer, laptop, or the like. The cryptographic wallet environment(s) 110 can have many similar components as those described with respect to validator nodes 120. For example, processor 210, I/O 220, memory 230, OS 240, and database 260 are substantially similar to processor 310, I/O 320, memory 330, OS 340, and database 360, and so a full description of these components are omitted here for brevity.

The cryptographic wallet 110 is configured to enable a user of cryptographic wallet 110 to interact with (e.g., sending/receiving cryptocurrency tokens, and/or entering into smart contracts implemented) system 100. The cryptographic wallet 110 can include memory 230 that may include one or more programs 350 to perform one or more functions of the disclosed examples. For example, the one or more programs 350 can include API 352 that can enable cryptographic wallet 110A to transact on system 100. For example, API 352 can enable cryptographic wallet 110A to send smart contract validation requests, license their granted smart contracts (e.g., between cryptographic wallet 110A and cryptographic wallet 110B), and/or report infringement events to validator nodes.

A cryptographic wallet is a program that can interact with a nodes of a blockchain (e.g., validator nodes 120) to store, send, and receive cryptocurrency tokens native to the blockchain. Each cryptographic wallet has associated public—private key pairs. A wallet cryptographic address is generated based on the public key pair associated with the cryptographic wallet. Users who are given the public key can transfer tokens to the cryptographic wallet associated with the public key, but are not able to spend the tokens without access to the private key. The private key can be used by a user of cryptographic wallet 110 to execute transactions (e.g., entering into a smart contract).

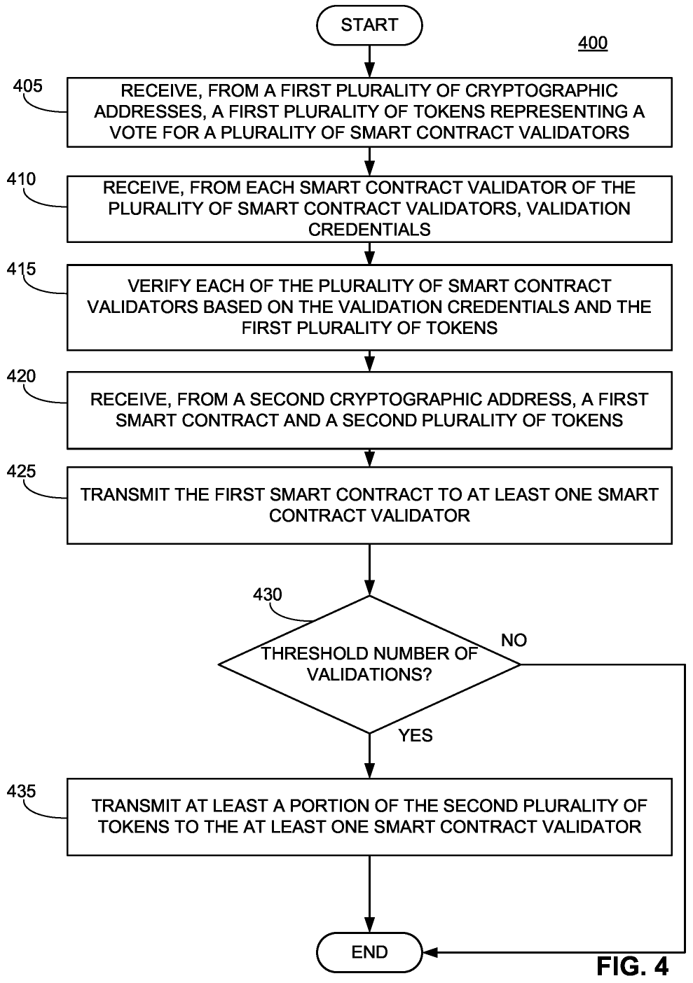

FIG. 4 is a flowchart of an example method for granting a smart contract, according to the present disclosure. In block 405, the method can include receiving, from a first plurality of cryptographic addresses, a first plurality of tokens representing a vote for a plurality of smart contract validators. The first plurality of cryptographic addresses (e.g., cryptographic wallet 110A, 110C, 110D etc.) provide votes for prospective smart contract validators (e.g., validator nodes 120) and pledge tokens to the prospective smart contract validators. According to some examples, in order to vote for a smart contract validator, a user can pledge a plurality of tokens in order for the vote to be counted by the blockchain system.

In block 410, the method can include receiving, from each prospective smart contract validator of the plurality of smart contract validators, validation credentials. For example, a qualifying college degree in physics, engineering, or another relevant field can be a requirement in order to be elected as a smart contract validator.

In block 415, the method can include verifying each of the plurality of smart contract validators based on the validation credentials and the first plurality of tokens. For example, the verification entity 130 can verify whether each of the prospective smart contract validators has provided sufficient validation credentials. The verification entity can additionally verify whether each prospective smart contract validator has received a predetermined threshold of tokens.

If both conditions are met, in block 420, the method can include receiving, from a second cryptographic address (e.g., cryptographic wallet 110B), a first smart contract and a second plurality of tokens. The first smart contract and the second plurality of tokens can be received by a respective validator node 120 of the plurality of validator nodes 120. As will be understood, in some examples, in order for a prospective smart contract to be granted, a user of cryptographic wallet 110B can provide a plurality of tokens as payment for the examination process. In block 425, the method can include transmitting the first smart contract to at least one smart contract validator (e.g., validator node 120A). For example, each validator node can have a number of tokens under its control. According to some examples, the validation node 120 may be selected probabilistically, with an increased probability for validation nodes 120 proportionally with an amount of cryptocurrency tokens that are “staked” to the respective validation node 120. For example, a validation node 120A may have 10,000 cryptocurrency tokens and validation node 120B may have 1,000 cryptocurrency tokens. If validation node 120A and validation node 120B are the only validation nodes 120 on system 100, then validation node 120A would have a ten times greater probability of being selected to validate the next transaction to be written to a block on the blockchain system.

In decision block 430, the method can include determining whether a threshold number of validations has been met. In some examples, it may be beneficial to validate the smart contract using at least one smart contract validator (e.g., validator node 120). In some examples, the smart contract may be validated by at least a plurality of smart contract validators (e.g., validator nodes 120). In yet other examples, the smart contract may be validated by a majority of the smart contract validators of system 100. According to some examples, each received smart contract can be compared to smart contracts that have already been granted by system 100 to determine whether the smart contract has novelty over previously granted smart contracts. In response to a threshold number of validations of the smart contract being met, the method may move to block 435. In response to the threshold number of validations of the smart contract not being met, the method may end. For example, in some examples, a consensus of at least 70 percent of smart contract validators may be the threshold for a smart contract to be granted. Accordingly, if at least 70 percent of smart contract validators approve a respective smart contract, the smart contract may be granted. According to some examples, the system can utilize technologies such as natural language processing to determine whether a respective smart contract includes one or more elements that were previously undisclosed in smart contracts previously submitted to the system (e.g., validator nodes 120). When the system determines that a respective smart contract includes elements not previously found in previously submitted smart contracts, the system can grant the respective smart contract.

In block 435, the method can include transmitting at least a portion of the second plurality of tokens to the at least one smart contract validator. For example, in response to the smart contract being validated by the smart contract validator (e.g., validator node 120A), validator node 120A can receive a reward of at least a plurality of the second plurality of tokens as an incentive of participation.

According to some examples, each of the first plurality of tokens and the second plurality of tokens are tokens native to blockchain system 100. That is, the first and second plurality of tokens are exclusively issued by validator nodes 120 of blockchain system 100.

According to some examples, the blockchain system 100 is a proof of stake system in which validator nodes 120 are chosen to validate smart contracts probabilistically based on a number of tokens in control of a respective validator node 120.

According to some examples, validating the smart contract can include determining whether the at least one smart contract validator (e.g., validator node 120) has an associated cryptographic address that controls at least a threshold number of tokens.

According to some examples, each smart contract can be a non-fungible token, which can be understood as a non-interchangeable unit of data stored on blockchain system 100 that proves ownership of the innovation represented by the smart contract.

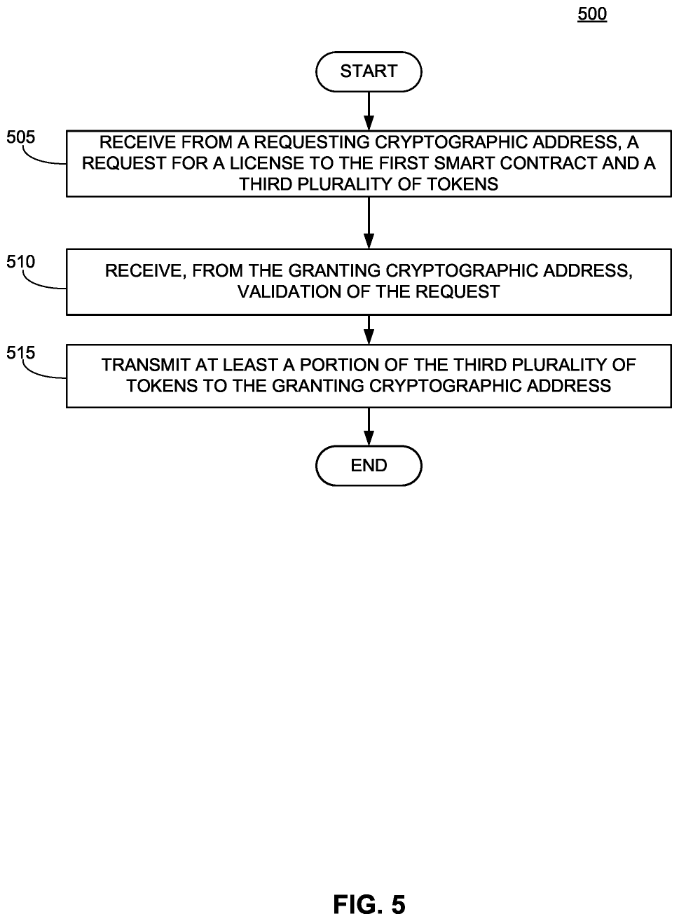

FIG. 5 is a flowchart of an example method for licensing a granted smart contract, according to the present disclosure. In block 505, the method can include receiving from a requesting cryptographic address, a request for a license to a granted smart contract and a third plurality of tokens. For example, cryptographic wallet 110A can have a first smart contract that has been granted by a validator node 120 as described with respect to method 400. In response, a user of cryptographic wallet 110B wants to practice the technology disclosed by the first smart contract. To do so, cryptographic wallet 110B can request a license to the first smart contract and provide a threshold number of tokens to purchase a license. According to some examples, the license can be either an exclusive license or a nonexclusive license. Exclusive licenses mean that there can only be a single licensee to the license. Nonexclusive licenses mean that another user of system 100 can subsequently request a license to the first smart contract.

In block 510, the method can include receiving, from the granting cryptographic address (e.g., cryptographic wallet 110A), a validation of the request. In some examples, the user of cryptographic wallet 110A can simply accept the terms of the license, including the number of tokens to be granted as part of the license. In some examples, the user of cryptographic wallet 110A can counter with modified terms, for example, changing the license from exclusive to nonexclusive and/or requesting a different number of tokens. Additional choices can be made as part of the license agreement, including whether sublicensing is acceptable to the user of cryptographic wallet 110A. In block 515, the method can include transmitting at least a portion of the third plurality of tokens to the granting cryptographic address.

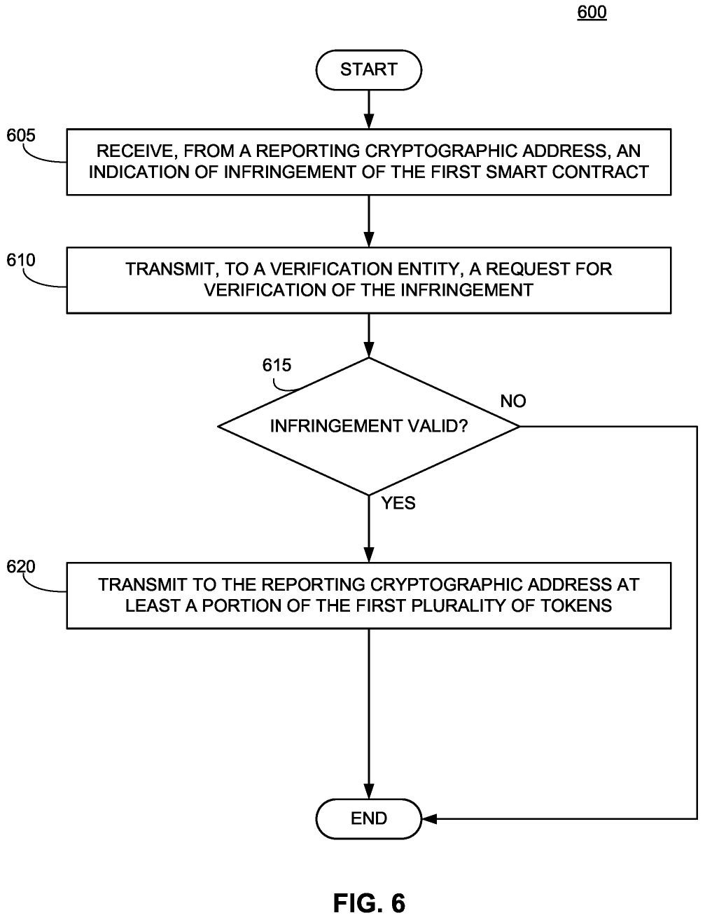

FIG. 6 is a flowchart of an example method for incentivizing reporting infringement events, according to the present disclosure. In block 605, the method can include receiving, from a reporting cryptographic address, an indication of infringement of the first smart contract. For example, a user of a cryptographic wallet (e.g., cryptographic wallet 110D) can report potential infringing activity to the system 100.

In block 610, the method can include, transmitting, to a verification entity, a request for verification of the infringement. For example, verification entity 130 can pull from off-blockchain data to determine whether infringement of the smart contract have occurred. That is, verification entity 130 can determine whether another entity has practiced the invention covered by the smart contract.

In decision block 615, based on the findings of the verification entity, the infringement report of block 605 can be determined as valid or invalid. In response to finding the infringement being invalid, the method may end. In response to finding the infringement being valid, the method can include transmitting to the reporting cryptographic address at least a portion of the first plurality of tokens in block 620. Accordingly, users reporting potential infringement of smart contracts are incentivized to report infringing activity.

While the present disclosure has been described in connection with a plurality of exemplary aspects, as illustrated in the various figures and discussed above, it is understood that other similar aspects can be used, or modifications and additions can be made, to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

The components described in this disclosure as making up various elements of the systems and methods are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

Examples of the present disclosure can be implemented according to at least the following clauses:

Clause 1: A system for granting smart contracts, the system comprising: a plurality of distributed processors; a plurality of distributed non-transitory memories in communication with the plurality of distributed processors and storing instructions, that when executed by the plurality of distributed processors are configured to cause the system to: receive, from a first plurality of cryptographic addresses, a first plurality of tokens comprising a vote for a plurality of smart contract validators; receive, from each smart contract validator of the plurality of smart contract validators, validation credentials; verify each of the plurality of smart contract validators based on the validation credentials and the first plurality of tokens; receive, from a second cryptographic address, a first smart contract and a second plurality of tokens; transmit the first smart contract to at least one smart contract validator of the plurality of smart contract validators; validate the first smart contract by the at least one smart contract validator; and transmit at least a portion of the second plurality of tokens to the at least one smart contract validator.

Clause 2: The system of clause 1, wherein the plurality of distributed non-transitory memories store instructions that when executed by the plurality of distributed processors are configured to cause the system to: receive from a third cryptographic address, a request for a license to the first smart contract and a third plurality of tokens; receive, from the second cryptographic address, validation of the request; and transmit at least a portion of the third plurality of tokens to the second cryptographic address.

Clause 3: The system of clause 1, wherein the plurality of distributed non-transitory memories store instructions that when executed by the plurality of distributed processors are configured to cause the system to: receive, from a fourth cryptographic address, an indication of infringement of the first smart contract; transmit, to an infringement validator entity, a request for verification of the infringement; receive verification of the infringement from the infringement validator entity; and responsive to receiving verification of the infringement, transmit to the fourth cryptographic address at least a portion of the first plurality of tokens.

Clause 4: The system of clause 2, wherein each token of the first plurality of tokens and the second plurality of tokens comprise a native token associated with a first blockchain implemented by the plurality of distributed processors.

Clause 5: The system of clause 4, wherein the first blockchain comprises a proof-of-stake blockchain.

Clause 6: The system of clause 2, wherein validating the first smart contract by the at least one smart contract validator further comprises verifying that a cryptographic address associated with the at least one smart contract validator comprises a threshold value of tokens.

Clause 7: The system of claim 3, wherein the infringement validator entity comprises a blockchain oracle.

Clause 8: The system of clause 1, wherein the first smart contract comprises a non-fungible token.

Clause 9: The system of clause 1, wherein the validation credentials comprise a qualifying university degree.

Clause 10: A system for granting smart contracts, the system comprising: a plurality of distributed processors; a plurality of distributed non-transitory memories in communication with the plurality of distributed processors and storing instructions, that when executed by the plurality of distributed processors are configured to cause the system to: receive, from a cryptographic address associated with a smart contract petitioner, a first smart contract and a first plurality of tokens; transmit the first smart contract to at least one smart contract validator of a plurality of smart contract validators; validate the first smart contract by the at least one smart contract validator; transmit at least a portion of the first plurality of tokens to the at least one smart contract validator; receive from a cryptographic address associated with a smart contract licensee, a request for a license to the first smart contract and a second plurality of tokens; receive, from the cryptographic address associated with the smart contract petitioner, validation of the request; and transmit at least a portion of the second plurality of tokens to the cryptographic address associated with the smart contract petitioner.

Clause 11: The system of clause 10, wherein the plurality of distributed non-transitory memories store instructions that when executed by the plurality of distributed processors are configured to cause the system to: receive, from a plurality of cryptographic addresses associated with a plurality of smart contract validator electors, a third plurality of tokens comprising a vote for a plurality of smart contract validators; receive, from each smart contract validator of the plurality of smart contract validators, validation credentials; and verify each of the plurality of smart contract validators based on the validation credentials and the third plurality of tokens.

Clause 12: The system of clause 10, wherein the plurality of distributed non-transitory memories store instructions that when executed by the plurality of distributed processors are configured to cause the system to: receive, from a cryptographic address associated with an infringement reporter, an indication of infringement of the first smart contract; transmit, to an infringement validator entity, a request for verification of the infringement; receive verification of the infringement from the infringement validator entity; and responsive to receiving verification of the infringement, transmit to the cryptographic address associated with the infringement reporter at least a portion of the first plurality of tokens.

Clause 13: The system of clause 10, wherein each token of the first plurality of tokens and the second plurality of tokens comprise a native token associated with a first blockchain implemented by the plurality of distributed processors.

Clause 14: The system of clause 13, wherein the first blockchain comprises a proof-of-stake blockchain.

Clause 15: The system of clause 10, wherein validating the first smart contract by the at least one smart contract validator further comprises verifying that a cryptographic address associated with the at least one smart contract validator comprises a threshold value of tokens.

Clause 16: The system of clause 12, wherein the infringement validator entity comprises a blockchain oracle.

Clause 17: A system for granting smart contracts, the system comprising: a plurality of distributed processors; a plurality of distributed non-transitory memories in communication with the plurality of distributed processors and storing instructions, that when executed by the plurality of distributed processors are configured to cause the system to: receive, from a first plurality of cryptographic addresses, a first plurality of tokens comprising a vote for a plurality of smart contract validators; receive, from each smart contract validator of the plurality of smart contract validators, validation credentials; and verify each of the plurality of smart contract validators based on the validation credentials and the first plurality of tokens.

Clause 18: The system of clause 17, wherein the plurality of distributed non-transitory memories store instructions that when executed by the plurality of distributed processors are configured to cause the system to: receive, from a second cryptographic address, a first smart contract and a second plurality of tokens; transmit the first smart contract to at least one smart contract validator of the plurality of smart contract validators; validate the first smart contract by the at least one smart contract validator; and transmit at least a portion of the second plurality of tokens to the at least one smart contract validator.

Clause 19: The system of clause 18, wherein the plurality of distributed non-transitory memories store instructions that when executed by the plurality of distributed processors are configured to cause the system to: receive, from a third cryptographic address, an indication of infringement of the first smart contract; transmit, to an infringement validator entity, a request for verification of the infringement; receive verification of the infringement from the infringement validator entity; and responsive to receiving verification of the infringement, transmit to the third cryptographic address at least a portion of the first plurality of tokens.

Clause 20: The system of claim 18, wherein each token of the first plurality of tokens and the second plurality of tokens comprise a native token associated with a first blockchain implemented by the plurality of distributed processors.

### Exemplary Use Cases

The following exemplary use cases describe examples of a typical user flow pattern. They are intended solely for explanatory purposes and not limitation.

Nancy would like to use the disclosed blockchain system to elect a smart contract validator. Nancy provides a vote for Albert by sending a number of cryptocurrency tokens (e.g., 10 tokens) to a cryptographic address associated with Albert. Albert makes his credentials available to the blockchain system, for example by uploading transcript records from his university or the like to a blockchain oracle (e.g., verification entity 130) which communicates with the system to verify Albert's qualifications. Other users of the system similarly provide votes for Albert, and several other smart contract examiners. A predetermined number of tokens may be required for a candidate to be selected as a smart contract examiner. For example, the protocol can require that at least 100 tokens are pledged to a cryptographic wallet associated with the potential smart contract examiner Albert is selected as he receives more than 100 tokens from a user of the system who wish to vote for him to become an examiner.

Larry wants to have his innovation protected by being recorded in the blockchain system. Accordingly, Larry transmits a smart contract to a smart contract examiner, such as Albert. Albert receives Larry's smart contract and compares Larry's innovation with those disclosed in smart contracts previously recorded onto the blockchain system. Finding that Larry's innovation is novel over the previously submitted smart contract, Albert submits a validation of Larry's smart contract. Albert's decision is broadcast to all the other smart contract validators within the blockchain system, and a majority of the smart contract examiner's verify Albert's decision. Accordingly, Larry's smart contract is finalized and permanently added to the blockchain. John, another user of the blockchain system, reports an infringement event of the teachings of Larry's smart contract. The infringement event can be verified by requesting information from an external blockchain oracle. In response, Larry is credited with tokens (e.g. 20 tokens) for reporting the infringement event.

In another example, Albert remains offline for a predetermined period of time after being selected as a smart contract examiner. The system determines that Albert has remained offline (e.g., has not accepted a smart contract) for the predetermined period of time, and executes a protocol to elect a new smart contract examiner. The system “slashes” the 100 tokens that are associated with Albert and redistributes these tokens to a Jonah, an examiner subsequently selected to validate smart contracts within the system.

What is claimed is:

1. A system for granting smart contracts, the system comprising:
a plurality of distributed processors;
a plurality of distributed non-transitory memories in communication with the plurality of distributed processors and storing instructions, that, when executed by the plurality of distributed processors, are configured to cause the system to:
receive, from a first plurality of cryptographic addresses, a first plurality of tokens comprising a vote for a plurality of smart contract validators;
receive, from each smart contract validator of the plurality of smart contract validators, validation credentials;
verify each of the plurality of smart contract validators based on the validation credentials and the first plurality of tokens;
receive, from a second cryptographic address, a first smart contract and a second plurality of tokens;
transmit the first smart contract to at least one smart contract validator of the plurality of smart contract validators;
validate the first smart contract by the at least one smart contract validator; and
transmit at least a portion of the second plurality of tokens to the at least one smart contract validator.

2. The system of claim 1, wherein the plurality of distributed non-transitory memories store instructions that when executed by the plurality of distributed processors are configured to cause the system to:
receive from a third cryptographic address, a request for a license to the first smart contract and a third plurality of tokens;
receive, from the second cryptographic address, validation of the request; and
transmit at least a portion of the third plurality of tokens to the second cryptographic address.

3. The system of claim 1, wherein the plurality of distributed non-transitory memories store instructions that when executed by the plurality of distributed processors are configured to cause the system to:
receive, from a fourth cryptographic address, an indication of infringement of the first smart contract;
transmit, to an infringement validator entity, a request for verification of the infringement;
receive verification of the infringement from the infringement validator entity; and
responsive to receiving verification of the infringement, transmit to the fourth cryptographic address at least a portion of the first plurality of tokens.

4. The system of claim 2, wherein each token of the first plurality of tokens and the second plurality of tokens comprise a native token associated with a first blockchain implemented by the plurality of distributed processors.

5. The system of claim 4, wherein the first blockchain comprises a proof-of-stake blockchain.

6. The system of claim 2, wherein validating the first smart contract by the at least one smart contract validator further comprises verifying that a cryptographic address associated with the at least one smart contract validator comprises a threshold value of tokens.

7. The system of claim 3, wherein the infringement validator entity comprises a blockchain oracle.

8. The system of claim 1, wherein the first smart contract comprises a non-fungible token.

9. The system of claim 1, wherein the validation credentials comprise a qualifying university degree.

10. A system for granting smart contracts, the system comprising:
a plurality of distributed processors;
a plurality of distributed non-transitory memories in communication with the plurality of distributed processors and storing instructions, that when executed by the plurality of distributed processors are configured to cause the system to:
receive, from a cryptographic address associated with a smart contract petitioner, a first smart contract and a first plurality of tokens;
transmit the first smart contract to at least one smart contract validator of a plurality of smart contract validators;
validate the first smart contract by the at least one smart contract validator;
transmit at least a portion of the first plurality of tokens to the at least one smart contract validator;
receive from a cryptographic address associated with a smart contract licensee, a request for a license to the first smart contract and a second plurality of tokens;
receive, from the cryptographic address associated with the smart contract petitioner, validation of the request; and
transmit at least a portion of the second plurality of tokens to the cryptographic address associated with the smart contract petitioner.

11. The system of claim 10, wherein the plurality of distributed non-transitory memories store instructions that when executed by the plurality of distributed processors are configured to cause the system to:
receive, from a plurality of cryptographic addresses associated with a plurality of smart contract validator electors, a third plurality of tokens comprising a vote for a plurality of smart contract validators;
receive, from each smart contract validator of the plurality of smart contract validators, validation credentials; and
verify each of the plurality of smart contract validators based on the validation credentials and the third plurality of tokens.

12. The system of claim 10, wherein the plurality of distributed non-transitory memories store instructions that when executed by the plurality of distributed processors are configured to cause the system to:
receive, from a cryptographic address associated with an infringement reporter, an indication of infringement of the first smart contract;
transmit, to an infringement validator entity, a request for verification of the infringement;
receive verification of the infringement from the infringement validator entity; and
responsive to receiving verification of the infringement, transmit to the cryptographic address associated with the infringement reporter at least a portion of the first plurality of tokens.

13. The system of claim 10, wherein each token of the first plurality of tokens and the second plurality of tokens comprise a native token associated with a first blockchain implemented by the plurality of distributed processors.

14. The system of claim 13, wherein the first blockchain comprises a proof-of-stake blockchain.

15. The system of claim 10, wherein validating the first smart contract by the at least one smart contract validator further comprises verifying that a cryptographic address associated with the at least one smart contract validator comprises a threshold value of tokens.

16. The system of claim 12, wherein the infringement validator entity comprises a blockchain oracle.

17. A system for granting smart contracts, the system comprising:
a plurality of distributed processors;
a plurality of distributed non-transitory memories in communication with the plurality of distributed processors and storing instructions, that when executed by the plurality of distributed processors are configured to cause the system to:
receive, from a first plurality of cryptographic addresses, a first plurality of tokens comprising a vote for a plurality of smart contract validators;
receive, from each smart contract validator of the plurality of smart contract validators, validation credentials; and
verify each of the plurality of smart contract validators based on the validation credentials and the first plurality of tokens.

18. The system of claim 17, wherein the plurality of distributed non-transitory memories store instructions that when executed by the plurality of distributed processors are configured to cause the system to:
receive, from a second cryptographic address, a first smart contract and a second plurality of tokens;
transmit the first smart contract to at least one smart contract validator of the plurality of smart contract validators;
validate the first smart contract by the at least one smart contract validator; and
transmit at least a portion of the second plurality of tokens to the at least one smart contract validator.

19. The system of claim 18, wherein the plurality of distributed non-transitory memories store instructions that when executed by the plurality of distributed processors are configured to cause the system to:
receive, from a third cryptographic address, an indication of infringement of the first smart contract;
transmit, to an infringement validator entity, a request for verification of the infringement;
receive verification of the infringement from the infringement validator entity; and
responsive to receiving verification of the infringement, transmit to the third cryptographic address at least a portion of the first plurality of tokens.

20. The system of claim 18, wherein each token of the first plurality of tokens and the second plurality of tokens comprise a native token associated with a first blockchain implemented by the plurality of distributed processors.
